(19) United States
(12) Patent Application Publication
(10) Pub. No.: US 2006/0010490 A1
(43) Pub. Date: Jan. 12, 2006

(54) Backup method

(75) Inventor: Satoshi Makita, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/189,653

(22) Filed: Jul. 26, 2005

Related U.S. Application Data
(63) Continuation of application No. PCT/JP03/07037, filed on Jun. 3, 2003.

(51) Int. Cl. G06F 15/16

(52) U.S. Cl. 726/9

(57) ABSTRACT

In the security media ID of a security MO disk, a unique ID of a backup source disk is written in 64 bytes following the unique ID of the security media ID of the backup destination disk. When using a security MO disk, the security media ID can be seen even before performing password authentication. Accordingly, by comparing the unique ID of the backup source disk in the security media ID of the backup destination disk to a unique ID of another disk, it is possible to quickly find the backup source disk of the backup destination disk.

### CROSS REFERENCE TO RELATED APPLICATION

This application is a continuation of international PCT application No. PCT/JP2003/007037 filed on Jun. 3, 2003.

### BACKGROUND OF THE INVENTION

1. Field of the Invention

The present invention relates to a method for backup of data files and so forth.

2. Description of the Related Art

Backup processing refers to copying all files in a backup source disk to a backup destination disk. The backup processing intends to copy all files in the backup source disk to the backup destination disk. For that reason, the backup processing can be either processing of copying all files in the backup source to a specific folder of the backup destination, or difference backup processing in which the backup source is compared with the backup destination, unnecessary files in the backup destination are deleted, and files not present in the backup destination are copied.

In carrying out backup, it is necessary to correspond a backup source disk to a backup destination disk. As one of the means for realizing this correspondence, there is a method for writing information for specifying the backup destination in the backup source. In the information for specifying disks, files with a volume serial number, a volume label, and special information written in are used.

In a case of security disks, the above determination is possible, if it is authenticated based on password. However, in the state in which the password is not authenticated, the information for specifying the disk is not accessible at all. Therefore, in the state that the password is not authenticated, the backup source could not be corresponded to the backup destination.

### SUMMARY OF THE INVENTION

It is an object of the present invention to provide a backup method for making correspondence between the backup source disk and the backup destination disk in the state that password is not authenticated.

The backup method in the present invention is a backup method, which cannot manipulate data content without authentication based on password, comprising a step of storing a unique ID comprised in a security media ID of a backup source media in a security media ID of a backup destination media and a step of making correspondence between a backup destination media and a backup source media by verifying a unique ID of the backup source media comprised in a security media ID of the backup destination media and a unique ID of the backup source media comprised in a security media ID of the backup source.

According to the present invention, because an ID unique to backup source media is stored in a security media ID, the backup source media can be readily corresponded to the backup destination media without password authentication.

### BRIEF DESCRIPTION OF THE DRAWINGS

FIG. 1 is an overall view of the embodiment of the present invention;

FIG. 2 is a configuration diagram of the security MO disk;

FIG. 3 is a diagram showing structure of the secure ID;

FIG. 4 is a diagram showing a structure of the secure ID according to the embodiment of the present invention;

FIG. 5 and FIG. 6 are diagrams showing other structures of the secure ID according to the embodiment of the present invention;

FIG. 7 is a flowchart showing processing flow in backup according to the embodiment of the present invention;

FIG. 8 is a flowchart showing generation procedure of the backup destination media;

FIG. 9 is a flowchart showing the processing flow in backup when using the specific ID;

FIG. 10 is a flowchart explaining generation procedures of the backup source media when using the specific ID;

FIG. 11 is a flowchart explaining generation procedures of the backup destination media when using the specific ID;

FIG. 12 is a flowchart explaining flow in backup in a case of a configuration using the specific ID and an identifier indicating the use of the present embodiment;

FIG. 13 is a flowchart showing generation procedures of the backup source media when using the specific ID and the identifier; and

FIG. 14 is a flowchart showing generation procedures of the backup destination media in the use of the specific ID and the identifier.

### DESCRIPTION OF THE PREFERRED EMBODIMENTS

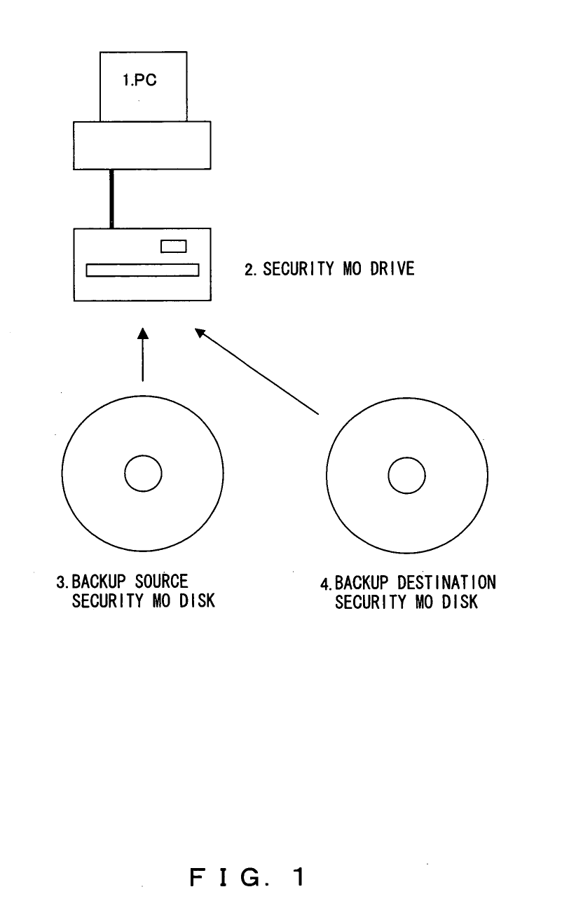

FIG. 1 is an overall view of the embodiment of the present invention.

In FIG. 1, 1 indicates a host PC, 2 indicates a security MO drive, 3 indicates a security MO disk of backup source, and 4 indicates a security MO disk of backup destination.

In this description, a security MO, security media, a security disk and so forth refer to media etc., which requires authentication based on password in order for users to see the content of the stored data.

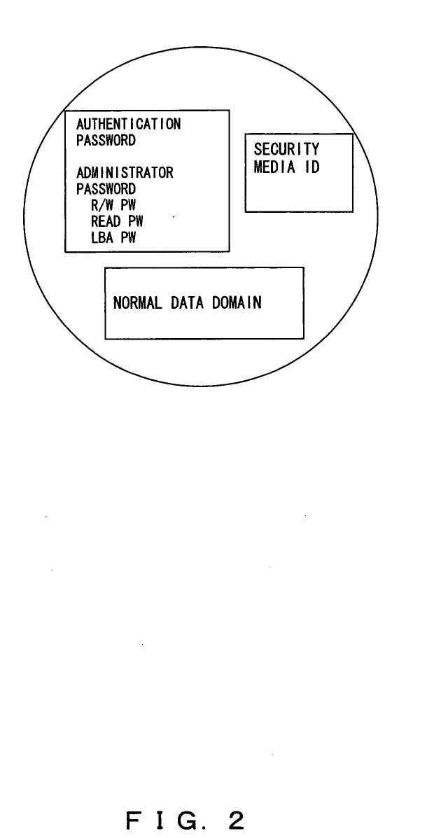

FIG. 2 is a configuration diagram of the security MO disk.

In FIG. 2, the security MO disk comprises security media ID (hereinafter referred to as a secure ID), password for authentication and normal data domain. The normal data domain, by being formatted, reads and writes files originated from PC. In order to write the normal data domain in the security MO disk, the user must be authenticated based on one of four kinds of authentication passwords. Authentication passwords are a R/W password for reading/writing, a read password, which is read-only, an LBA password, which is accessible only from a section of the media, and an administrator password for allowing reference of the content of the media even when the user forgot the password.

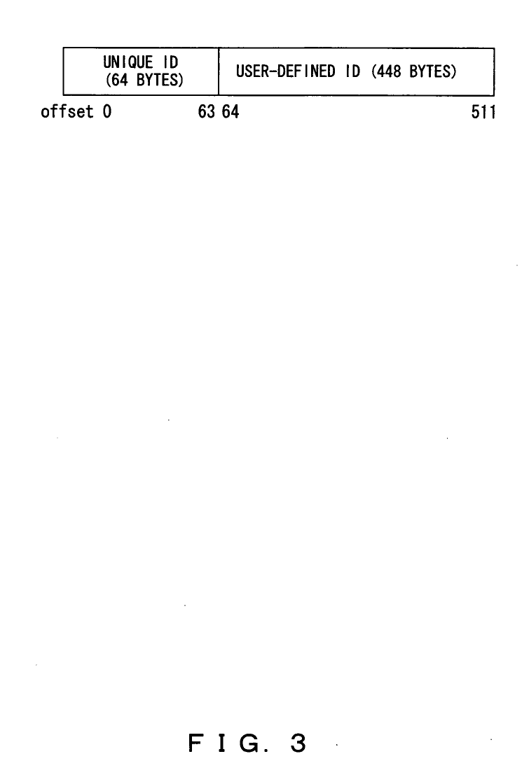

FIG. 3 is a diagram showing structure of the secure ID.

The secure ID is 512-byte value, written in a disk by the security MO drive. Once the secure ID is written in, the value cannot be deleted or changed. In the secure ID, a value automatically generated by the security MO drive is used for 64 bytes from the top. This is called a unique ID. Because the unique ID uses a serial number of the MO drive and a serial number of the security MO disk created in the drive, it is less likely to have unique ID sections overlapped between a plurality of security MO disks. For 448 bytes other than the unique ID, any value can be used depending on programs. This is called a user-defined ID. Even when the unique ID sections duplicate between a plurality of the security MO disks, uniqueness of the secure ID can be maintained as long as the user-defined IDs do not duplicate. As an example for maintaining uniqueness, there is a method that creation timestamp is made for a value of 8 bytes in the user-defined ID. It can be said that uniqueness of 72-byte value, a combination of the unique ID of 8 bytes and 64 bytes, can be maintained. Also, the secure ID can be read out even if the user is not authenticated based on the authentication password.

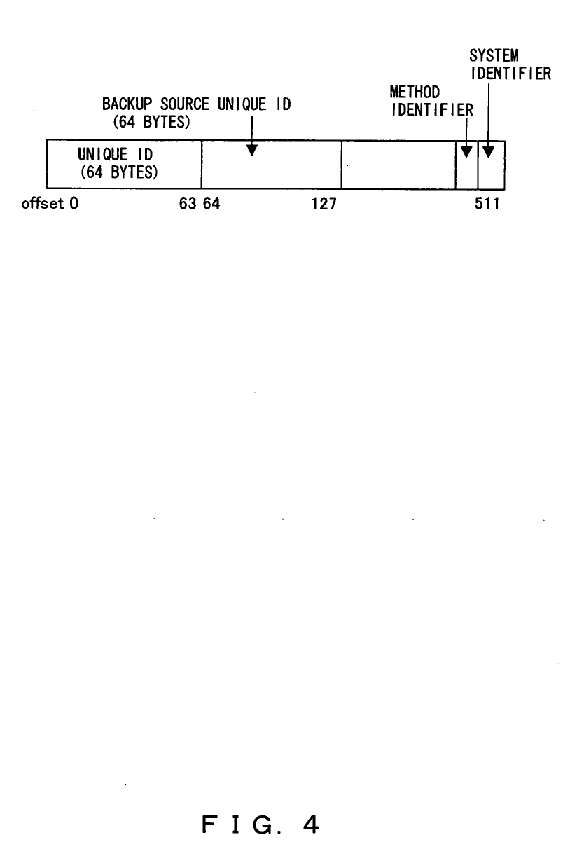

FIG. 4 is a diagram showing a structure of the secure ID according to the embodiment of the present invention.

In carrying out backup of the security MO disk, the secure ID of its own disk is written on other MO disk, and it is used as a security MO disk. When generating the secure ID, the unique ID of the backup source is used for the 64 bytes of the user-defined ID. For example, as shown in FIG. 4, the unique ID of the backup source is used for 64 bytes (64 bytes from the top of the user-defined ID) following the unique ID of the backup destination.

When carrying out backup to the backup destination disk with the secure ID set in the manner described above, whether or not it is the backup destination disk can be determined without the entry of authentication password.

In the backup source ID used for the user-defined domain of the secure ID of the backup destination, by adding a part of the user-defined ID to the backup source unique ID, the backup source can unfailingly correspond to the backup destination. For example, when using 72 bytes including the timestamp in the unique ID as shown in the above example, it can be realized by acquiring 72 bytes from the top of the backup source secure ID for the backup destination secure ID, and by using 72 bytes among the backup destination user-defined ID. With this method, maximum of 256 bytes of the backup secure ID can be used.

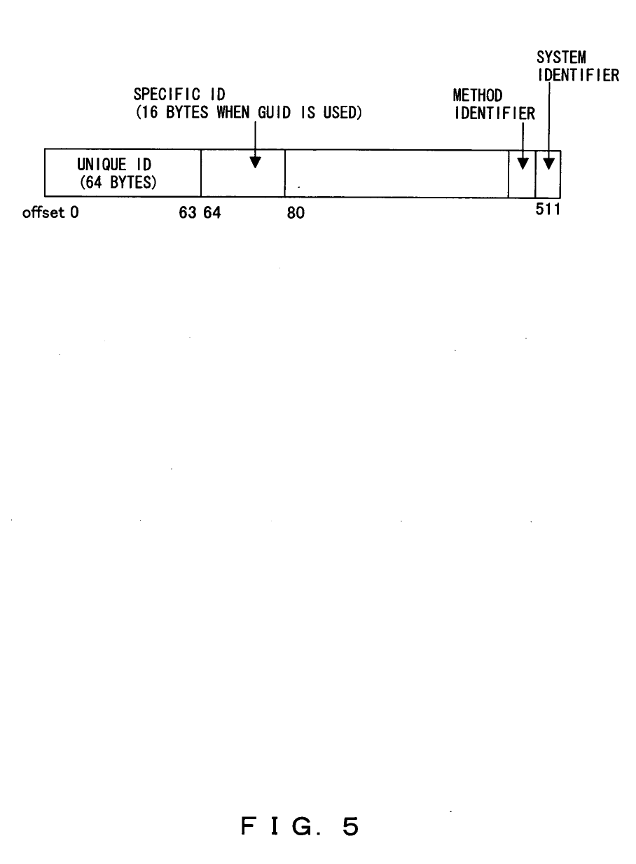

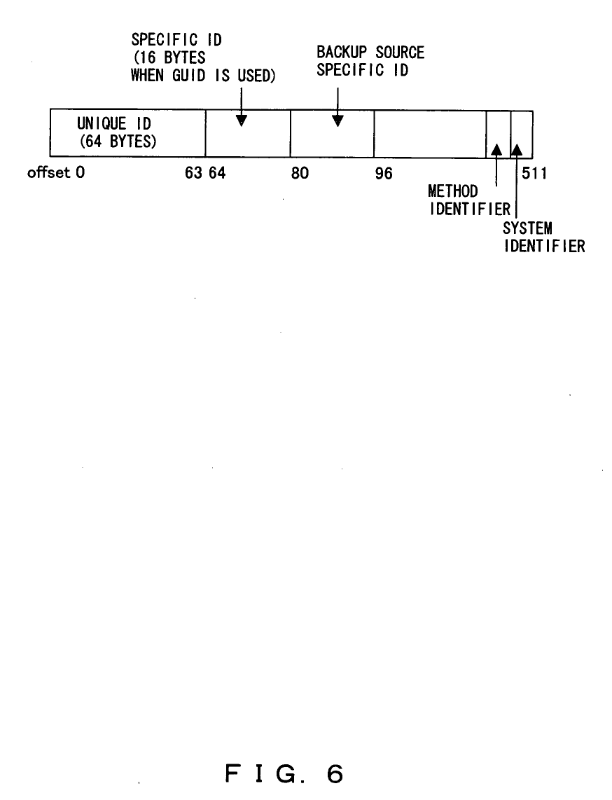

FIG. 5 and FIG. 6 are diagrams showing other structures of the secure ID according to the embodiment of the present invention.

The unique ID is written in automatically by the drive in setting of the secure ID; however, it can also be realized by writing a unique specific ID in a predetermined position of the user-defined domain when setting the secure ID, and then writing a specific ID of the backup source to a predetermined position of the user-defined domain of the backup destination. As for the specific ID, GUID of Windows (registered trademark) etc. can be used.

When the backup source and the backup destination use the same position as the insertion position of the specific ID, by writing a backup destination identifier, for identifying the backup destination, in a predetermined position of the secure ID, the backup destination disk can be identified.

By writing a system identifier, indicating that the backup source disk and the backup destination disk uses the system of the present embodiment, in a predetermined position of the secure ID, the disk not using the present system can be distinguished.

By writing a method identifier, indicating that the backup source disk and the backup destination disk uses the unique ID method of the present invention, in a predetermined position of the secure ID, the disk not using the present system can be distinguished.

When using the specific ID, by writing position information and length information of the specific ID into a predetermined position of the secure ID, the specific ID can be arbitrarily set. The position information can be an offset from the top of the secure ID. The backup destination disk may have the specific IDs in two separate positions; however in such a case, the position information and the length information of both positions are written in the secure ID.

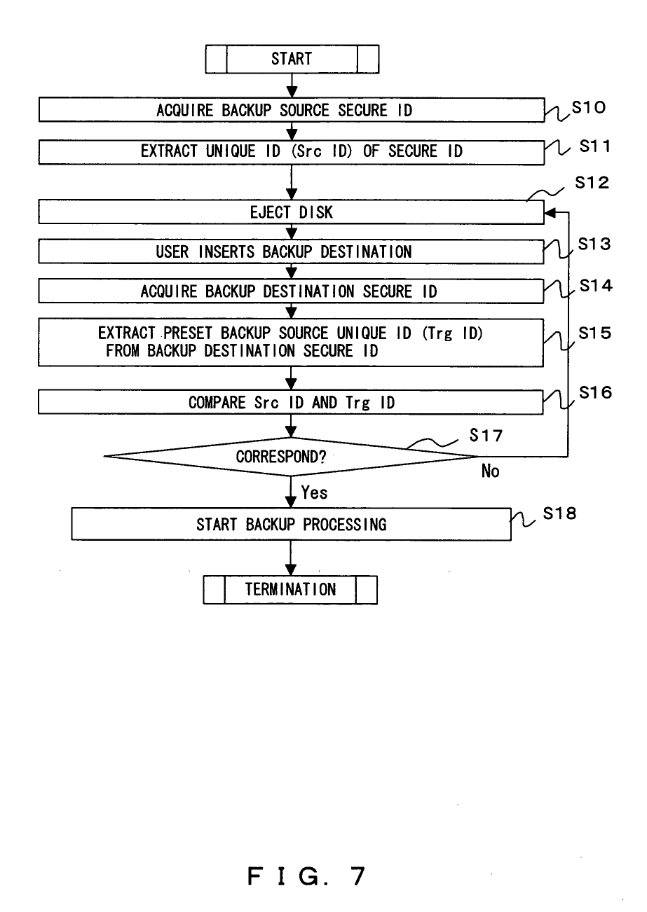

FIG. 7 is a flowchart showing processing flow in backup according to the embodiment of the present invention.

In the step S10, the backup source secure ID is acquired. In the step S11, the backup source secure ID (Src ID) is extracted, and in the step S12, the backup source disk is ejected from the security drive. In the step S13, a user inserts the backup destination into the security disk drive, and in the step 14, the secure ID of the backup destination is acquired. In the step S15, a preset backup source unique ID (Trg ID) is extracted, and in the step S16 the Src ID and the Trg ID are compared. In the step S17, whether the Src ID and the Trg ID correspond or not is determined. When they do not correspond to each other, the processing goes back to the step S12. When the correspondence is determined in the step S17, in the step S18, backup processing starts. When the backup processing is completed, the processing is terminated. The backup processing in this description is the same as in the regular backup processing of the secure disk, and the explanation is omitted, as it is conventional art.

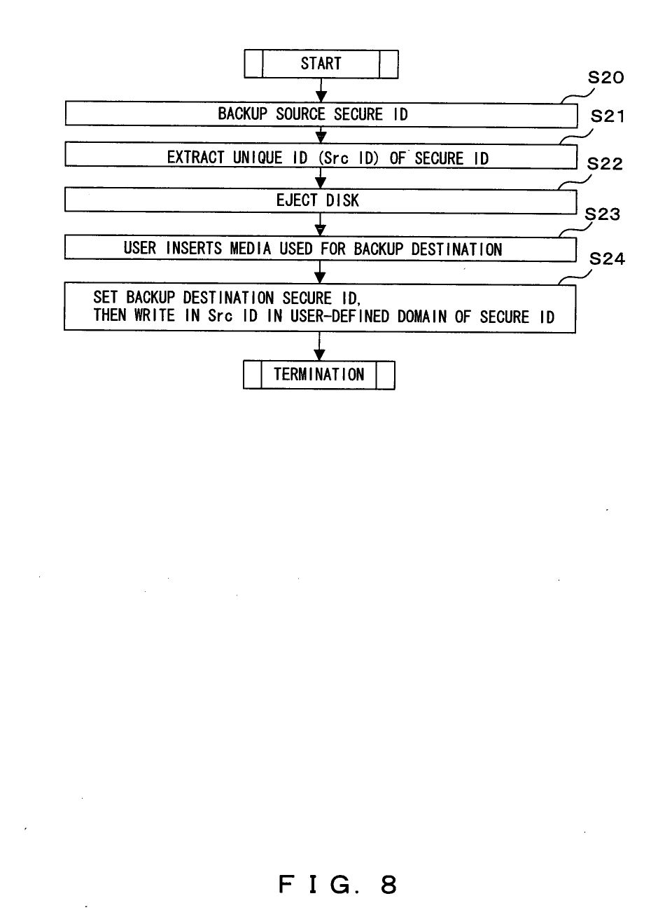

FIG. 8 is a flowchart showing generation procedures of the backup destination media.

First, in the step S20, the backup source secure ID is acquired. In the step S21, the unique ID (Src ID) of the secure ID is extracted, and in the step S22, the backup source disk is ejected from the security disk drive. In the step S23, the user inserts media used as the backup destination into the security disk drive, and in the step S24, sets the backup destination secure ID. At that time, the Src ID is written in the user-defined domain of the secure ID, and the processing is terminated.

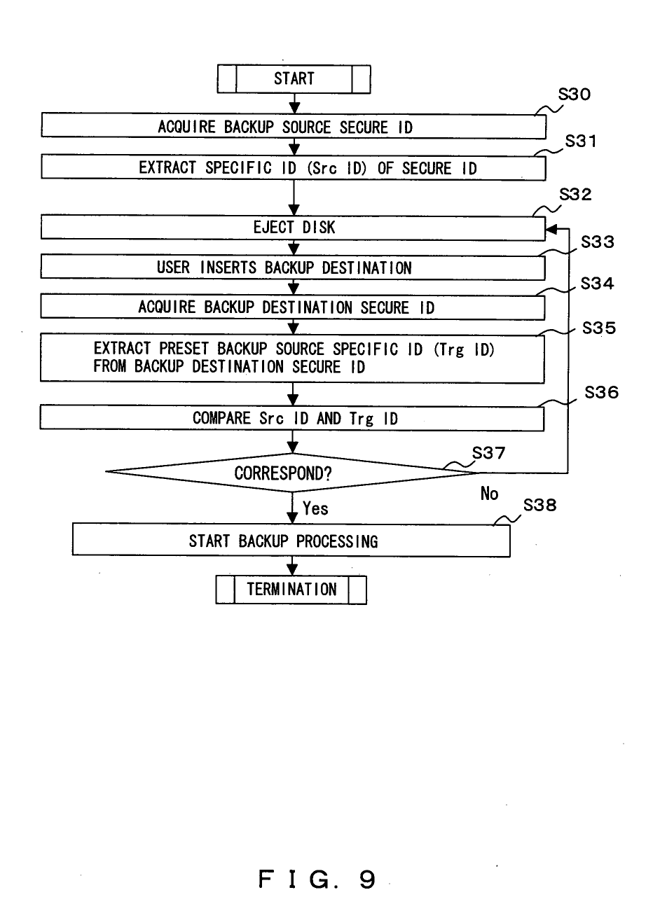

FIG. 9 is a flowchart showing the processing flow in backup when using the specific ID.

In the step S30, the backup source secure ID is acquired, in the step S31 the specific ID (Src ID) of the secure ID is extracted, and in the step S32 the backup source disk is ejected. In the step S33 the user inserts the backup destination disk, in the step S34 the backup destination secure ID is acquired, in the step S35 a preset backup source specific ID (Trg ID) is extracted from the backup destination secure ID, and in the step S36 the Src ID and the Trg ID are compared with each other. In the step S37, when they did not correspond, the processing goes back to the step S32, whereas, when they correspond in the step S37, in the step S38, the backup processing starts, and when the backup processing is completed, the whole processing is terminated.

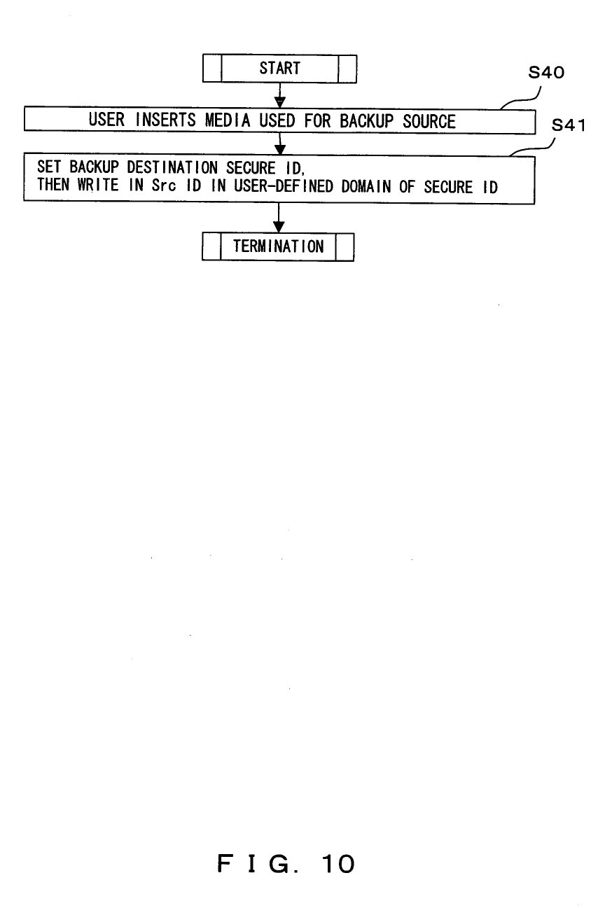

FIG. 10 is a flowchart explaining generation procedures of the backup source media when the specific ID is used.

In the step S40, media, which a user uses as the backup source is inserted in the security disk drive. In the step S41, the backup source secure ID is set. At that time, the Src ID is written in the user-defined domain of the secure ID, and the processing terminates.

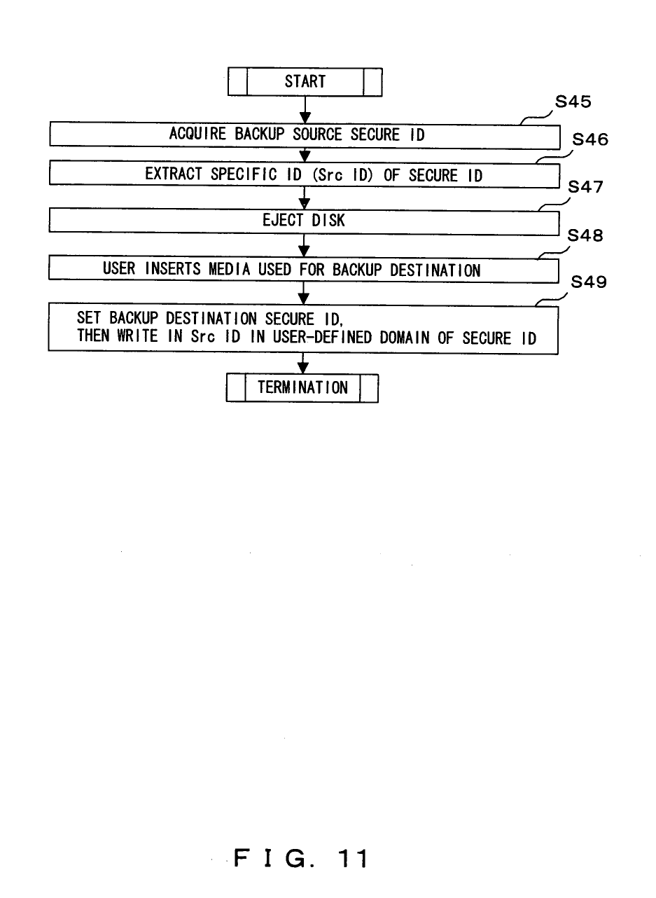

FIG. 11 is a flowchart explaining generation procedures of the backup destination media when the specific ID is used.

In the step S45, the backup source secure ID is acquired. In the step S46, the specific ID (Src ID) of the secure ID is extracted. In the step S47, backup source disk is ejected, and in the step S48, a user inserts the media used as the backup destination. In the step S49, the backup destination secure ID is set, and Src ID is written in the user-defined domain of the secure ID.

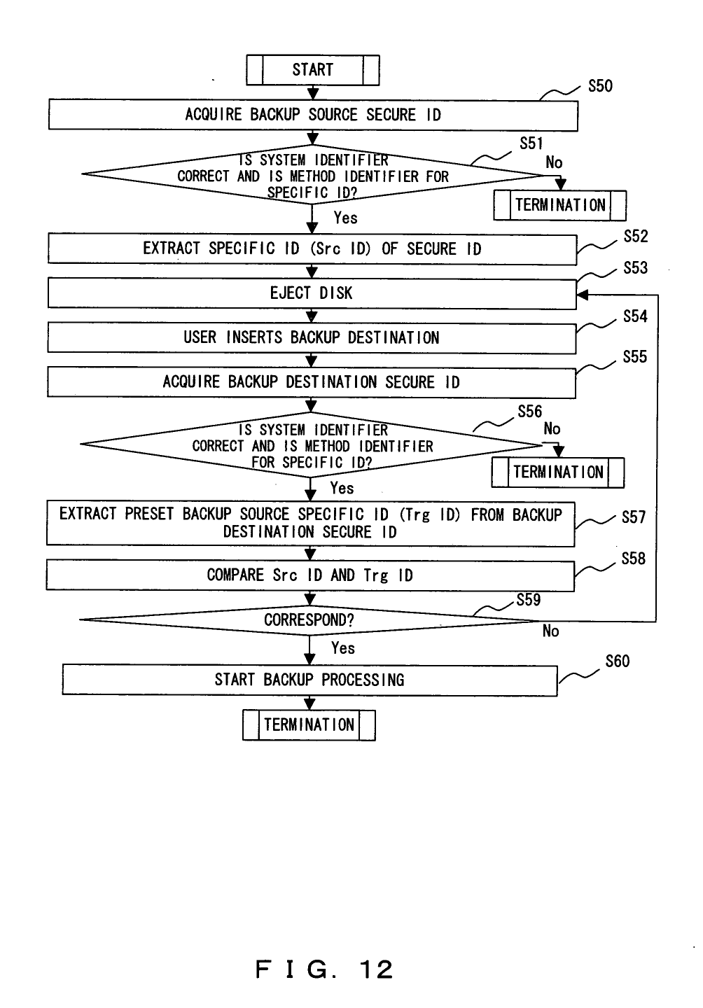

FIG. 12 is a flowchart explaining flow of backup in a case of a configuration using the specific ID and an identifier indicating the use of the present embodiment.

In the step S50, the backup source secure ID is acquired. In the step S51, whether or not the identifier indicates the use of the system of the embodiment of the present invention (whether a system identifier is accurate and a method identifier is for the specific ID or not) is determined. When the determination of the step S51 is NO, the processing terminates. When the determination in the step S51 is YES, in the step S52, the specific ID (Src ID) of the secure ID is extracted, and in the step S53, the backup source disk is ejected from the security disk drive. In the step S54, a user inserts the backup destination into the security disk drive, and in the step S55, the backup destination secure ID is acquired. In the step S56, whether or not the identifier of the backup destination secure ID indicates the use of the system of the embodiment of the present invention (whether a system identifier is accurate and a method identifier is for the specific ID or not) is determined. When the determination of the step S56 is NO, the processing terminates. When the determination of the step S56 is YES, in the step S57, a preset backup source specific ID (Trg ID) is extracted, and in the step S58, the Src ID and the Trg ID are compared to each other. In the step S59, correspondence in these IDs are determined, and when they do not correspond, the processing goes back to the step S53, whereas when they correspond, in the step S60, the backup processing is started. When the backup processing is completed, the processing terminates.

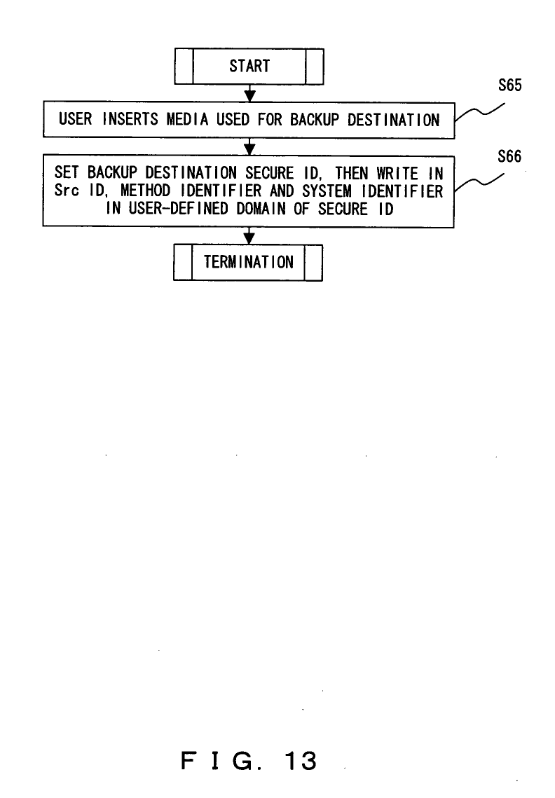

FIG. 13 is a flowchart showing generation procedure of the backup source media when using the specific ID and the identifier.

In the step S65, a user inserts media used as the backup source into the security disk drive. In the step S66, the backup source secure ID is set. At that time, the Src ID, the method identifier and the system identifier are written into the user-defined domain of the secure ID, and the processing terminates.

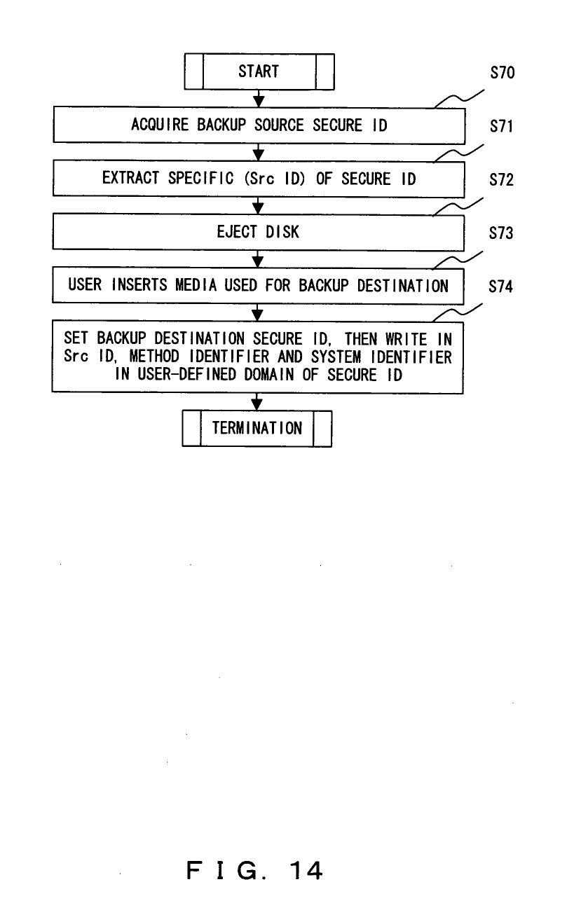

FIG. 14 is a flowchart showing generation procedures of the backup destination media in the use of the specific ID and the identifier.

In the step S70, the backup source secure ID is acquired, in the step S71, the specific ID (Src ID) of the secure ID is extracted, and in the step S72, the disk is ejected from the security disk drive. In the step S73, the user inserts media used as the backup destination into the security disk drive, and in the step S74, the backup destination secure ID is set. At that time, after writing the Src ID, the method identifier and system identifier into the user-defined domain of the secure ID, the processing terminates.

Users had been required, after the entry of password of the disk and authentication of the disk, to determine whether the disk is the correct backup destination disk or not; however, in the present invention, because password authentication is performed after determining the correct backup destination disk, the users are not required to repeat the entry of password for determining the backup destination disk.

What is claimed is:

1. A backup method in a security media system, comprising:
storing a unique ID comprised in a security media ID of a backup source media in a security media ID of a backup destination media; and
corresponding a backup source media to a backup destination media by verifying a unique ID of the backup source media comprised in a security media ID of the backup destination media and a unique ID of the backup source media comprised in a security media ID of the backup source.

2. The backup method according to claim 1, which is used for a security media system unable to manipulate data contents without authentication based on password.

3. The backup method according to claim 1, wherein a specific ID uniquely given to the backup source is used as the unique ID, and the specific ID is stored in the security media ID of the backup source media and the backup destination media.

4. The backup method according to claim 3, wherein the specific ID is a GUID.

5. The backup method according to claim 1, wherein identifiers, indicating that the unique ID of the backup source is comprised in the security media ID of the backup destination, are stored in the security media ID of media of the backup source and that of the backup destination.

6. The backup method according to claim 1, wherein the media is a disk medium.

7. A system, comprising:
a unit for storing a unique ID comprised in a security media ID of a backup source media in a security media ID of a backup destination media; and
a unit for corresponding a backup source media to a backup destination media by verifying a unique ID of the backup source media comprised in a security media ID of the backup destination media and a unique ID of the backup source media comprised in a security media ID of the backup source.

8. A program causing an information processor device to realize a backup, comprising:
storing a unique ID comprised in a security media ID of a backup source media in a security media ID of a backup destination media; and
corresponding a backup source media to a backup destination media by verifying a unique ID of the backup source media comprised in a security media ID of the backup destination media and a unique ID of the backup source media comprised in a security media ID of the backup source.

9. A recording media, readable to an information processor device, comprising a program causing the information processor device to realize a backup method, comprising:
storing a unique ID comprised in a security media ID of a backup source media in a security media ID of a backup destination media; and
corresponding a backup source media to a backup destination media by verifying a unique ID of the backup source media comprised in a security media ID of the backup destination media and a unique ID of the backup source media comprised in a security media ID of the backup source.
